(19) United States
(12) Patent Application Publication
(10) Pub. No.: US 2021/0075590 A1
(43) Pub. Date: Mar. 11, 2021

(54) METHOD AND APPARATUS FOR ESTABLISHING BLOCKCHAIN NODE CONNECTION, AND DEVICE

(71) Applicant: HUAWEI TECHNOLOGIES CO., LTD., Shenzhen (CN)

(72) Inventors: Fei YANG, Beijing (CN); Xue YANG, Beijing (CN); Bingyang LIU, Beijing (CN); Xinpeng WEI, Beijing (CN); Shoushou REN, Beijing (CN)

(21) Appl. No.: 17/099,382

(22) Filed: Nov. 16, 2020

Related U.S. Application Data
(63) Continuation of application No. PCT/CN2020/074848, filed on Feb. 12, 2020.

(30) Foreign Application Priority Data
Feb. 20, 2019 (CN) 201910126002.8

(51) Int. Cl. H04L 9/06; H04L 9/08; H04L 12/721; H04L 12/755; H04L 29/12

(52) U.S. Cl. CPC H04L 9/0637; H04L 9/0825; H04L 2209/38; H04L 45/021; H04L 61/6022; H04L 45/44

(57) ABSTRACT

Embodiments of this application provide a method and an apparatus for establishing a blockchain node connection, and a device. The method is applied to a blockchain system, and includes: A first node obtains address information of a second node from a first router. The first router and the first node are located in a first autonomous system. The second node is located in a second autonomous system. The first autonomous system and the second autonomous system are neighboring autonomous systems. The first node establishes a connection to the second node based on the address information of the second node. This improves blockchain communication security.

### CROSS-REFERENCE TO RELATED APPLICATIONS

This application is a continuation of International Application No. PCT/CN2020.074848, filed on Feb. 12, 2020, which claims priority to Chinese Patent Application No. 201910126002.8, filed on Feb. 20, 2019. The disclosures of the aforementioned applications are hereby incorporated by reference in their entireties.

### TECHNICAL FIELD

This application relates to the field of communications technologies, and in particular, to a method and an apparatus for establishing a blockchain node connection, and a device.

### BACKGROUND

At present, a blockchain system may be created by using a plurality of technologies (such as an Ethereum technology).

A blockchain system includes a plurality of blockchain nodes (referred to as nodes for short below). A node may include a node table, and the node may add, to the node table, a node that has been in contact with the node recently and that is reachable for the node. After the node is started, the node may establish a connection to the node in the node table. However, in an actual application process, a plurality of attack nodes may repeatedly send a connection request to a node, to make the node add the attack nodes to a node table, so that after the node is started, all outgoing connections of the node are connections to the attack nodes, and consequently the node is surrounded by the attack nodes. In other words, nodes to which the node establishes connections are all attack nodes, and consequently the node is controlled by the attack nodes. This results in relatively low communication security.

### SUMMARY

This application provides a method and an apparatus for establishing a blockchain node connection, and a device, to improve blockchain communication security.

According to a first aspect, an embodiment of this application provides a method for establishing a blockchain node connection. The method is applied to a blockchain system, and the method may include: A first node obtains address information of a second node from a first router, and establishes a connection to the second node based on the address information of the second node. The first router and the first node are located in a first autonomous system, the second node is located in a second autonomous system, and the first autonomous system and the second autonomous system are neighboring autonomous systems.

In the foregoing process, after the first node in the first autonomous system is started, the first node first obtains the address information of the second node in the second autonomous system (where the first autonomous system and the second autonomous system are neighbors), and establishes the connection to the second node based on the address information of the second node. Because the first autonomous system and the second autonomous system are neighbors, the second node in the second autonomous system is a non-attack node, so that the first node can be connected to at least one non-attack node. This can avoid that nodes to which the first node establishes connections are all attack nodes, and further avoid that the first node is controlled by the attack nodes, thereby improving blockchain communication security.

In a possible implementation, that a first node obtains address information of a second node from a first router includes: The first node receives a first message from the first router. The first message includes the address information of the second node. The first message is one of a border gateway protocol BGP message, a resource public key infrastructure to router RTR interface protocol message, or a self-defined interface message.

When the first message is a BGP message, an existing BGP open message may be extended, so that the BGP open message may indicate whether a device sending the BGP open message has a capability of carrying the address information of the node. An existing BGP update message is extended, so that the BGP update message can carry the address information of the node. In this way, the first node in the first AS can obtain the address information of the second node in the second AS by using the BGP update message, and then the first node can first establish the connection to the second node based on the address information of the second node. It is only required that the existing BGP messages need to be extended so that the BGP messages can carry the address information, and therefore blockchain communication security can be improved by slightly modifying an existing solution.

When the first message is an RTR message, a new RTR message is defined, so that the first node in the first AS can obtain the address information of the second node in the second AS by using the RTR message (an RTR content message), and then the first node can first establish the connection to the second node based on the address information of the second node.

When the first message is a self-defined interface message, a self-defined interface message is defined, so that the first node in the first AS can obtain the address information of the second node in the second AS by using the self-defined interface message, and then the first node can first establish the connection to the second node based on the address information of the second node.

In the foregoing process, after obtaining the address information of the second node, the first router may send the address information of the second node to the first node, so that the first node can obtain the address information of the second node in time.

In a possible implementation, before the first node receives the first message from the first router, the method further includes: The first node sends a request message to the first router. The request message is used to request to obtain the address information of the node in the neighboring autonomous system of the first autonomous system.

In the foregoing process, the first node obtains, by using the request message, the address information of the second node from the first router only when the first node needs to use the address information of the second node. This avoids unnecessary information sending performed by the first router, thereby avoiding a waste of signaling.

In a possible implementation, address information of the first node includes at least one of an identifier of the first node, an IP address of the first node, a MAC address of the first node, or a blockchain account of the first node, and the address information of the second node includes at least one of an identifier of the second node, an IP address of the second node, a MAC address of the second node, or a blockchain account of the second node.

In a possible implementation, the first node may further send the address information of the first node to the first router. In this way, the first router can obtain the address information of the first node, and send the address information of the first node to a router in the neighboring autonomous system of the first autonomous system, so that the router in the neighboring autonomous system of the first autonomous system can obtain the address information of the first node in time.

In a possible implementation, that the first node sends the address information of the first node to the first router includes: The first node sends a second message to the first router. The second message includes the address information of the first node. The second message is one of a BGP message, an RTR message, or a self-defined interface message.

In a possible implementation, before the first node establishes the connection to the second node based on the address information of the second node, the method includes: The first node adds the address information of the second node to a neighbor table of the first node.

Correspondingly, that the first node establishes a connection to the second node based on the address information of the second node includes: The first node establishes the connection to the second node based on the address information in the neighbor table.

In the foregoing process, the neighbor table includes the address information of the node in the neighboring autonomous system of the first autonomous system, and therefore the first node can establish the connection to the node in the neighboring autonomous system of the first autonomous system based on the address information in the neighbor table, where the node in the neighboring autonomous system of the first autonomous system is a non-attack node. In this way, the first node can establish a connection to the non-attack node, thereby improving blockchain communication security.

In a possible implementation, after the first node establishes the connection to the second node based on the address information of the second node, the method further includes: The first node establishes a connection to a third node, and obtains a first valid-node table from the third node. The first node obtains a second valid-node table from the second node. The first node determines a target valid-node table from the first valid-node table and the second valid-node table, and performs node discovery based on the target valid-node table.

In the foregoing process, the third node may be an endorsement node. By using the foregoing process, a problem that the first node is attacked because of malicious behavior of the endorsement node can be avoided.

According to a second aspect, an embodiment of this application provides a method for establishing a blockchain node connection. The method is applied to a blockchain system, and the method includes: A first router obtains address information of a second node, where the second node is located in a second autonomous system. The first router sends the address information of the second node to a first node, where the first router and the first node are located in a first autonomous system, and the first autonomous system and the second autonomous system are neighboring autonomous systems.

In the foregoing process, after the first node in the first autonomous system is started, the first node first obtains the address information of the second node in the second autonomous system (where the first autonomous system and the second autonomous system are neighbors), and establishes a connection to the second node based on the address information of the second node. Because the first autonomous system and the second autonomous system are neighbors, the second node in the second autonomous system is a non-attack node, so that the first node can be connected to at least one non-attack node. This can avoid the nodes to which the first node establishes connections being all attack nodes, and further avoid that the first node is controlled by the attack nodes, thereby improving blockchain communication security.

In a possible implementation, that the first router sends the address information of the second node to a first node includes: The first router sends a first message to the first node. The first message includes the address information of the second node. The first message is one of a border gateway protocol BGP message, a resource public key infrastructure to router RTR interface protocol message, or a self-defined interface message.

When the first message is a BGP message, an existing BGP open message may be extended, so that the BGP open message may indicate whether a device sending the BGP open message has a capability of carrying the address information of the node. An existing BGP update message is extended, so that the BGP update message can carry the address information of the node. In this way, the first node in the first AS can obtain the address information of the second node in the second AS by using the BGP update message, and then the first node can first establish the connection to the second node based on the address information of the second node. It is only required that the existing BGP messages need to be extended so that the BGP messages can carry the address information, and therefore blockchain communication security can be improved by slightly modifying an existing solution.

When the first message is an RTR message, a new RTR message is defined, so that the first node in the first AS can obtain the address information of the second node in the second AS by using the RTR message (an RTR content message), and then the first node can first establish the connection to the second node based on the address information of the second node.

When the first message is a self-defined interface message, a self-defined interface message is defined, so that the first node in the first AS can obtain the address information of the second node in the second AS by using the self-defined interface message, and then the first node can first establish the connection to the second node based on the address information of the second node.

In the foregoing process, after obtaining the address information of the second node, the first router may send the address information of the second node to the first node, so that the first node can obtain the address information of the second node in time.

In a possible implementation, before the first router sends the first message to the first node, the method further includes: The first router receives a first request message sent by the first node. The first request message is used to request to obtain the address information of the node in the neighboring autonomous system of the first autonomous system.

In the foregoing process, the first router sends the first message to the first node only after receiving the first message sent by the first node. This avoids unnecessary information sending performed by the first router, thereby avoiding a waste of signaling.

In a possible implementation, that a first router obtains address information of a second node includes: The first router receives a first border gateway protocol BGP message from a second router. The first BGP message includes the address information of the second node, and the second router is located in the second autonomous system.

In a possible implementation, before the first router sends the address information to the first node, the method further includes: The first router obtains an autonomous system path length of the address information, where the autonomous system path length is used to indicate a quantity of autonomous systems that the address information has passed through when the first router receives the address information. The first router determines that the autonomous system path length of the address information is 1.

In the foregoing process, when the first router determines that the autonomous system path length of the address information is 1, it can be ensured that the address information is the address information of the node in the neighboring autonomous system of the first autonomous system, and it can be determined that the first node can establish the connection to the node in the neighboring autonomous system of the first autonomous system based on the address information.

In a possible implementation, the first router receives a second message sent by the first node. The second message includes address information of the first node. The second message is at least one of a BGP message, a resource public key infrastructure to router RTR interface protocol message, or a self-defined interface message.

In a possible implementation, the address information of the first node includes at least one of an identifier of the first node, an IP address of the first node, a MAC address of the first node, or a blockchain account of the first node, and the address information of the second node includes at least one of an identifier of the second node, an IP address of the second node, a MAC address of the second node, or a blockchain account of the second node.

In a possible implementation, before the first router receives the second message sent by the first node, the method further includes: The first router sends a second request message to the first node. The second request message is used to request to obtain the address information of the first node.

In a possible implementation, after the first router receives the address information of the first node sent by the first node, the method further includes: The first router sends a second BGP message to the second router. The second BGP message includes the address information of the first node.

According to a third aspect, an embodiment of this application provides a method for establishing a blockchain node connection. The method includes: A first node obtains address information of a second node, and adds the address information of the second node to a neighbor table of the first node. After the first node is started, the first node establishes a connection to the second node based on the address information in the neighbor table.

In the foregoing process, the neighbor table includes the address information of the node in a neighboring autonomous system of a first autonomous system, and therefore the first node can establish the connection to the node in the neighboring autonomous system of the first autonomous system based on the address information in the neighbor table, where the node in the neighboring autonomous system of the first autonomous system is a non-attack node. In this way, the first node can establish a connection to the non-attack node, thereby improving blockchain communication security.

In a possible implementation, the first node may further obtain address information of another node in the neighboring autonomous system of the first autonomous system and update the neighbor table based on the address information of the another node. In this way, the neighbor table can include address information of a plurality of nodes in the neighboring autonomous system of the first autonomous system.

In a possible implementation, after the first node establishes the connection to the second node based on the address information in the neighbor table, the first node may further perform node discovery based on node information in a node table, and establish a connection to a discovered node.

It should be noted that in the third aspect, for a process of obtaining the address information of the second node by the first node, refer to the first aspect. Details are not described herein again.

According to a fourth aspect, an embodiment of this application provides a method for establishing a blockchain node connection. The method includes: A first node obtains address information of a second node, and establishes a connection to the second node based on the address information of the second node. The first node establishes a connection to a third node, and obtains a first valid-node table from the third node. The first node obtains a second valid-node table from the second node. The first node determines a target valid-node table from the first valid-node table and the second valid-node table, and performs node discovery based on the target valid-node table.

In the foregoing process, the third node may be an endorsement node. By using the foregoing process, a problem that the first node is attacked because of malicious behavior of the endorsement node can be avoided.

It should be noted that in the fourth aspect, for a process of obtaining the address information of the second node by the first node, refer to the first aspect. Details are not described herein again.

According to a fifth aspect, an embodiment of this application provides an apparatus for establishing a blockchain node connection. The apparatus is applied to a first node in a blockchain system, and the apparatus includes:

a receiving module, configured to obtain address information of a second node from a first router, where the first router and the first node are located in a first autonomous system, the second node is located in a second autonomous system, and the first autonomous system and the second autonomous system are neighboring autonomous systems; and

a processing module, configured to establish a connection to the second node based on the address information of the second node.

In a possible implementation, the receiving module is specifically configured to receive a first message from the first router. The first message includes the address information of the second node. The first message is one of a border gateway protocol BGP message, a resource public key infrastructure to router RTR interface protocol message, or a self-defined interface message.

In a possible implementation, the apparatus further includes a sending module.

The sending module is configured to: before the receiving module receives the first message from the first router, send a request message to the first router. The request message is used to request to obtain the address information of the node in the neighboring autonomous system of the first autonomous system.

In a possible implementation, address information of the first node includes at least one of an identifier of the first node, an IP address of the first node, a MAC address of the first node, or a blockchain account of the first node.

The address information of the second node includes at least one of an identifier of the second node, an IP address of the second node, a MAC address of the second node, or a blockchain account of the second node.

In a possible implementation, before the processing module establishes the connection to the second node based on the address information of the second node, the processing module is further configured to add the address information of the second node to a neighbor table of the first node.

The processing module is specifically configured to establish the connection to the second node based on the address information in the neighbor table.

In a possible implementation, after the processing module establishes the connection to the second node based on the address information of the second node, the processing module is further configured to:

establish a connection to a third node, and obtain a first valid-node table from the third node;

obtain a second valid-node table from the second node; and

determine a target valid-node table from the first valid-node table and the second valid-node table, and perform node discovery based on the target valid-node table.

In a possible implementation, the sending module is further configured to send the address information of the first node to the first router.

In a possible implementation, the sending module is specifically configured to send a second message to the first router. The second message includes the address information of the first node. The second message is one of a BGP message, an RTR message, or a self-defined interface message.

According to a sixth aspect, an embodiment of this application provides an apparatus for establishing a blockchain node connection. The apparatus is applied to a first router in a blockchain system, and the apparatus includes:

a receiving module, configured to obtain address information of a second node, where the second node is located in a second autonomous system; and

a sending module, configured to send the address information of the second node to the first node, where the first router and the first node are located in a first autonomous system, and the first autonomous system and the second autonomous system are neighboring autonomous systems.

In a possible implementation, the sending module is specifically configured to send a first message to the first node. The first message includes the address information of the second node. The first message is one of a border gateway protocol BGP message, a resource public key infrastructure to router RTR interface protocol message, or a self-defined interface message.

In a possible implementation, the receiving module is further configured to: before the sending module sends the first message to the first node, receive a first request message sent by the first node. The first request message is used to request to obtain the address information of the node in the neighboring autonomous system of the first autonomous system.

In a possible implementation, the receiving module is specifically configured to receive a first border gateway protocol BGP message from a second router. The first BGP message includes the address information of the second node, and the second router is located in the second autonomous system.

In a possible implementation, the apparatus further includes a processing module.

The processing module is configured to: before the sending module sends the address information to the first node, obtain an autonomous system path length of the address information, and determine that the autonomous system path length of the address information is 1, where the autonomous system path length is used to indicate a quantity of autonomous systems that the address information has passed through when the first router receives the address information.

In a possible implementation, the receiving module is further configured to receive a second message sent by the first node. The second message includes address information of the first node. The second message is at least one of a BGP message, a resource public key infrastructure to router RTR interface protocol message, or a self-defined interface message.

In a possible implementation, the address information of the first node includes at least one of an identifier of the first node, an IP address of the first node, a MAC address of the first node, or a blockchain account of the first node.

The address information of the second node includes at least one of an identifier of the second node, an IP address of the second node, a MAC address of the second node, or a blockchain account of the second node.

In a possible implementation, the sending module is further configured to: before the receiving module receives the second message sent by the first node, send a second request message to the first node. The second request message is used to request to obtain the address information of the first node.

In a possible implementation, the sending module is further configured to: after the receiving module receives the address information of the first node sent by the first node, send a second BGP message to the second router. The second BGP message includes the address information of the first node.

According to a seventh aspect, an embodiment of this application provides an apparatus for establishing a blockchain node connection, including a memory and a processor. The processor executes a program instruction in the memory, to implement the method for establishing a blockchain node connection in the first aspect.

According to an eighth aspect, an embodiment of this application provides an apparatus for establishing a blockchain node connection, including a memory and a processor. The processor executes a program instruction in the memory, to implement the method for establishing a blockchain node connection in the second aspect.

According to a ninth aspect, an embodiment of this application provides a computer-readable storage medium. The storage medium is configured to store a computer program. When being executed by a computer or a processor, the computer program is used to implement the methods for establishing a blockchain node connection in the foregoing aspects.

According to a tenth aspect, an embodiment of this application provides a computer program product including an instruction. When the computer program product is run on a computer, the computer is enabled to perform the methods for establishing a blockchain node connection in the foregoing aspects.

According to the method and the apparatus for establishing a blockchain node connection, and the device that are provided in embodiments of this application, after the first node in the first AS is started, the first node first obtains the address information of the second node in the second AS (where the first AS and the second AS are neighbors), and establishes the connection to the second node based on the address information of the second node. Because the first AS and the second AS are neighbors, the second node in the second AS is a non-attack node, so that the first node can be connected to at least one non-attack node. This can avoid that nodes to which the first node establishes connections are all attack nodes, and further avoid that the first node is controlled by the attack nodes, thereby improving blockchain communication security.

### BRIEF DESCRIPTION OF DRAWINGS

FIG. 1 is a diagram of a system architecture according to an embodiment of this application:

FIG. 2 is a schematic flowchart of a method for establishing a blockchain node connection according to an embodiment of this application;

FIG. 3 is a schematic structural diagram of a BGP update message according to an embodiment of this application;

FIG. 4 is a schematic flowchart of another method for establishing a blockchain node connection according to an embodiment of this application:

FIG. 5 is a schematic diagram of message forwarding according to an embodiment of this application;

FIG. 6 is a schematic structural diagram of a BGP open message according to an embodiment of this application;

FIG. 7A and FIG. 7B are schematic diagrams of a process of establishing a node connection according to an embodiment of this application;

FIG. 8 is a schematic flowchart of still another method for establishing a blockchain node connection according to an embodiment of this application;

FIG. 9 is a schematic structural diagram of a message according to an embodiment of this application:

FIG. 10 is a schematic structural diagram of another message according to an embodiment of this application:

FIG. 11 is a schematic structural diagram of still another message according to an embodiment of this application:

FIG. 12 is a schematic flowchart of yet another method for establishing a blockchain node connection according to an embodiment of this application:

FIG. 13 is a schematic flowchart of still yet another method for establishing a blockchain node connection according to an embodiment of this application;

FIG. 14 is a schematic diagram of a process of establishing a node connection according to this application:

FIG. 15 is a schematic flowchart of a further method for establishing a blockchain node connection according to an embodiment of this application;

FIG. 16 is a schematic structural diagram of an apparatus for establishing a blockchain node connection according to an embodiment of this application;

FIG. 17 is a schematic structural diagram of another apparatus for establishing a blockchain node connection according to an embodiment of this application;

FIG. 18 is a schematic structural diagram of still another apparatus for establishing a blockchain node connection according to an embodiment of this application;

FIG. 19 is a schematic structural diagram of yet another apparatus for establishing a blockchain node connection according to an embodiment of this application;

FIG. 20 is a schematic structural diagram of hardware of an apparatus for establishing a blockchain node connection according to this application; and

FIG. 21 is a schematic structural diagram of hardware of another apparatus for establishing a blockchain node connection according to this application.

### DESCRIPTION OF EMBODIMENTS

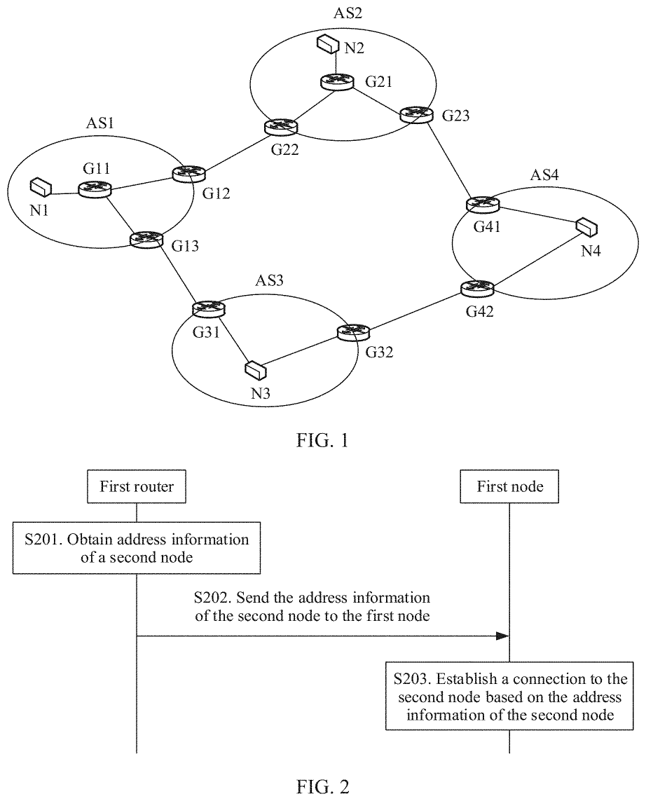

FIG. 1 is a diagram of a system architecture according to an embodiment of this application. Referring to FIG. 1, the system architecture includes a plurality of autonomous systems (AS), and at least one blockchain node (referred to as a node below) and at least one border router are disposed in each AS.

Optionally, the node in this application may be a server provided by an Internet service provider (ISP).

Optionally, a border router is a router disposed at an edge of an AS, and the border router may communicate with a border router in another AS. For example, referring to FIG. 1, a router G12 and a router G13 in an AS1 are border routers, a router G22 and a router G23 in an AS2 are border routers, a router G31 and a router G32 in an AS3 are border routers, and G41 and G42 in an AS4 are border routers. An AS may further include a route reflector, and the route reflector may forward a message between a node in the AS and a border router in the AS. For example, the AS1 includes a route reflector G11, and the AS2 includes a route reflector G21. It should be noted that in an AS, a node may directly communicate with a border router, or may communicate with a border router by using a route reflector.

A neighbor relationship between different ASs may be configured. Optionally, a neighbor relationship between ASs may be preconfigured, or a neighbor relationship between ASs may be configured through negotiation between border routers in different ASs. Optionally, one or more neighboring ASs may be configured for one AS. If two ASs are configured to be neighbors, a node in one AS and a node in the other AS are neighbors. For a node in any AS, it may be considered that a node in a neighboring AS of the AS is a non-attack node. For example, if the AS and the AS2 are neighbors, for a node in the AS1, nodes in the AS2 are all non-attack nodes.

Optionally, border routers in different ASs may be configured to configure a neighbor relationship between different ASs. An address of a border router in an AS may be added to a border router in another AS, and the address may be set to a router address corresponding to the neighboring AS. For example, assuming that the AS1 includes a border router 1 and the AS2 includes a border router 2, an address of the border router 2 may be added to the border router 1, and the address of the border router 2 may be set to a router address corresponding to the neighboring AS of the AS1; and an address of the border router 1 may be added to the border router 2, and the address of the border router 1 may be set to a router address corresponding to the neighboring AS of the AS2.

In this application, after a first node in a first AS is started, the first node first obtains address information of a second node in a second AS (where the first AS and the second AS are neighbors), and establishes a connection to the second node based on the address information of the second node. Because the first AS and the second AS are neighbors, the second node in the second AS is a non-attack node, so that the first node can be connected to at least one non-attack node. This can avoid that nodes to which the first node establishes connections are all attack nodes, and further avoid that the first node is controlled by the attack nodes, thereby improving blockchain communication security.

Specific embodiments are used below to describe in detail the technical solutions of this application. It should be noted that the following several embodiments may be used in combination. Same or similar content is not repeated in different embodiments.

It should be noted that in the embodiments of this application, an example is used for description in which a first router and a first node are disposed in a first AS, a second router and a second node are disposed in a second AS, and the first AS and the second AS are neighbors.

FIG. 2 is a schematic flowchart of a method for establishing a blockchain node connection according to an embodiment of this application. Referring to FIG. 2, the method may include the following steps.

S201. A first router obtains address information of a second node.

The second node is located in a second AS, and the second node is any node that has been started in the second AS.

Optionally, the first router may be a border router in a first AS.

Optionally, the address information of the second node includes at least one of an identifier of the second node, an IP address of the second node, a MAC address of the second node, or a blockchain account of the second node.

The identifier of the second node may be an identification (ID) of the second node.

For example, when a blockchain is implemented based on an Ethereum technology, the address information of the second node may include the identifier of the second node and the IP address of the second node, or the address information of the second node may include the identifier of the second node, the IP address of the second node, and the blockchain account of the second node.

Optionally, the first router may obtain the address information of the second node from a second router. The second router may be a border router in the second AS. For example, an address of the first router may be added to the second router. After obtaining the address information of the second node, the second router may send the address information of the second node to the first router based on the address of the first router.

Optionally, the first router may receive a Border Gateway Protocol (BGP) message sent by the second router, where the BGP message includes the address information of the second node.

Optionally, an existing BGP update message may be extended, so that the BGP update message carries the address information.

For example, the first router may receive the BGP update message sent by the second router, where the BGP update message includes the address information of the second node.

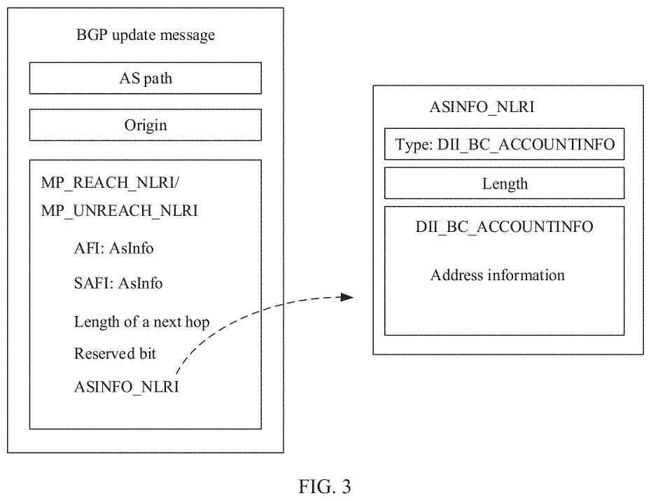

The following describes a structure of the BGP update message in this application with reference to FIG. 3.

FIG. 3 is a schematic structural diagram of a BGP update message according to an embodiment of this application. Referring to FIG. 3, the BGP update message includes an AS path (AS-Path) attribute, an origin attribute, and a multiprotocol reachable network layer reachable information (MP_REACH_NLRI)/multiprotocol unreachable network layer reachable information (MP_UNREACH_NLRI) attribute. The MP_REACH_NLRI/MP_UNREACH_NLRI attribute includes an address family identifier (AFI), a subsequent address family identifier (SAFI), a length of a next hop, a reserved bit, and autonomous system information_network layer reachable information (ASINFO_NLRI). ASINFO_NLRI is an extended attribute in the existing BGP update message in this application, and the BGP message can carry address information of a node by using the extended attribute. A DII_BC_ACCOUNTINFO attribute is defined in ASINFO_NLRI that is obtained through extension, and the DII_BC_ACCOUNTINFO attribute includes the address information of the node. Optionally, the address information of the node includes at least one of an identifier of the node, an IP address of the node, a MAC address of the node, or a blockchain account of the node.

It should be noted that, when a plurality of ASs are neighbors of the first AS, and the address of the first router is added to all border routers in the plurality of neighboring ASs, the first router may obtain address information of a plurality of nodes from a plurality of routers.

For example, it is assumed that an AS1 includes a router 1 and a node 1, an AS2 includes a router 2 and a node 2, and an AS3 includes a router 3 and a node 3. It is assumed that the AS1 and the AS2 are neighbors, the AS1 and the AS3 are neighbors, an address of the router 1 is added to the router 2 as a router address corresponding to the neighboring AS, and the address of the router 1 is also added to the router 3 as a router address corresponding to the neighboring AS. In this case, the router 1 may obtain address information of the node 2 from the router 2, and the router 2 may further obtain address information of the node 3 from the router 3.

S202. The first router sends the address information of the second node to a first node.

Both the first router and the first node are located in the first AS. The first router may directly send the address information of the second node to the first node, or the first router may send the address information of the second node to the first node by using another router in the first AS.

Optionally, after obtaining the address information of the second node, the first router may cache the address information of the second node, and send the address information of the second node to the first node after the first node is started next time. After the first node is started, the first node sends, to the first router, a message used to indicate that the first node has been started. Therefore, the first router may send the address information of the second node to the first node after receiving the message.

Optionally, the first router may proactively send the address information of the second node to the first node. Alternatively, the first router may send the address information of the second node to the first node after receiving a request message of the first node.

S203. The first node establishes a connection to the second node based on the address information of the second node.

Optionally, the first node may send a connection establishment request to the second node based on the address information of the second node, to establish the connection to the second node.

Optionally, after S203 is performed, the first node may further establish a connection to another node. For example, the first node may request, based on a node table stored in the first node, to establish a connection to another node, or the first node may receive a connection request sent by another node, to establish a connection to the another node.

According to the method for establishing a blockchain node connection provided in this embodiment of this application, after the first node in the first AS is started, the first node first obtains the address information of the second node in the second AS (where the first AS and the second AS are neighbors), and establishes the connection to the second node based on the address information of the second node. Because the first AS and the second AS are neighbors, the second node in the second AS is a non-attack node, so that the first node can be connected to at least one non-attack node. This can avoid that nodes to which the first node establishes connections are all attack nodes, and further avoid that the first node is controlled by the attack nodes, thereby improving blockchain communication security.

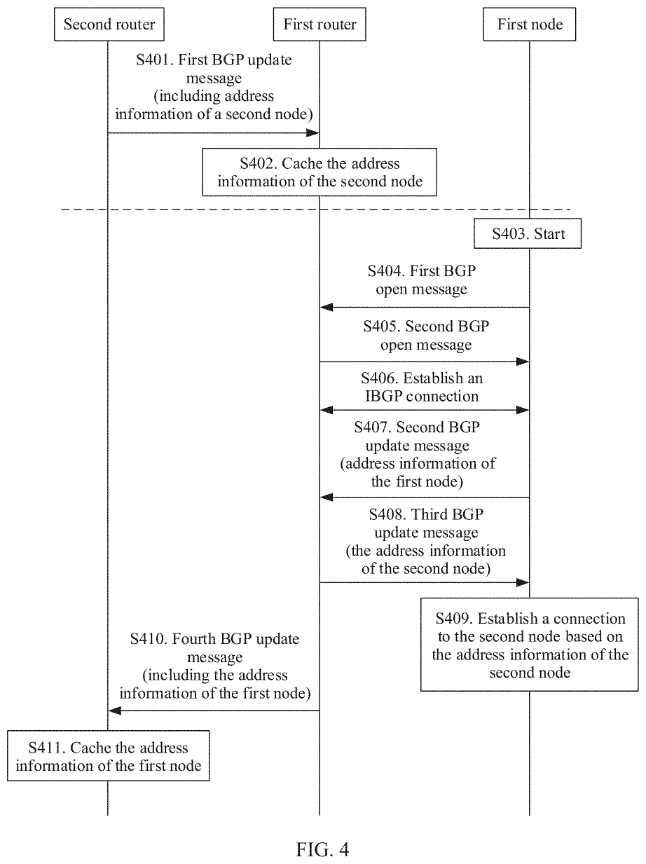

Based on any of the foregoing embodiments, the following details the method in the foregoing method embodiment with reference to embodiments shown in FIG. 4 to FIG. 6.

FIG. 4 is a schematic flowchart of another method for establishing a blockchain node connection according to an embodiment of this application. Referring to FIG. 4, the method may include the following steps.

S401. A second router sends a first BGP update message to a first router.

The first BGP update message includes address information of a second node.

Optionally, the second node is currently in a started state.

Optionally, after obtaining the address information of the second node, the second router may proactively send the first BGP update message to the first router.

Optionally, the first BGP update message may include address information of a plurality of second nodes; or the second router may send a plurality of first BGP update messages to the first router, where each first BGP update message includes address information of one second node. In this way, the first router can obtain address information of all second nodes that have been started currently in a second AS.

Optionally, there may be one or more second routers. When there are a plurality of second routers, the plurality of second routers may be located in different ASs, and the ASs in which all the second routers are located are all neighbors of an AS in which the first router is located.

For example, it is assumed that the first router is a router 1, and the first router is located in an AS1; there are two second routers: a router 2 and a router 3, where the router 2 is located in an AS2, and the router 3 is located in an AS3; and the AS1 and the AS2 are neighbors, and the AS1 and the AS3 are also neighbors. In this case, the router 2 may send address information of a node in the AS2 to the router 1, and the router 3 may send address information of a node in the AS3 to the router 1.

It should be noted that for a structure of the first BGP update message, refer to FIG. 3. Details are not described herein again.

S402. The first router caches the address information of the second node based on the first BGP update message.

Optionally, the first router may obtain the address information of the second node from the first BGP update message, and cache the address information of the second node.

It should be noted that the first router may receive a first BGP update message sent by one or more second routers. If receiving first BGP update messages sent by a plurality of second routers, the first router caches address information of a second node in each first BGP update message.

Optionally, after receiving the first BGP update message, the first router may determine, based on the first BGP update message, whether the second node is a node in the neighboring AS of a first AS.

Optionally, the first BGP update message includes an AS path, and the first router may determine an AS path length based on the AS path. The AS path length is used to indicate a quantity of autonomous systems that the first BGP update message has passed through during transmission of the first BGP update message. If the AS path length is 1, it is determined that the second node is a node in the neighboring AS of the first AS. If the AS path length is greater than 1, it is determined that the second node is not a node in the neighboring AS of the first AS.

Optionally, each time the BGP update message passes through an AS, the BGP update message carries an identifier of the AS. Correspondingly, the first router may determine the path length based on a quantity of AS identifiers included in the AS path in the first BGP update message. The path length may be the quantity of AS identifiers included in the AS path.

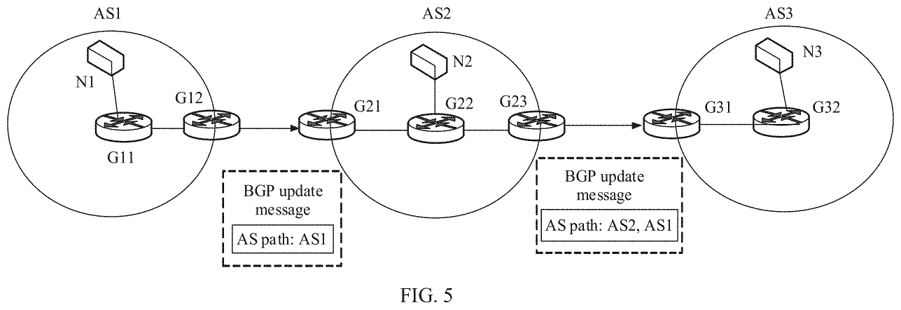

The following describes the path length with reference to FIG. 5.

FIG. 5 is a schematic diagram of message forwarding according to an embodiment of this application. Referring to FIG. 5, an AS1, an AS2, and an AS3 are included. A node N1, a route reflector G11, and a router G12 are disposed in the AS1. A node N2, a router G21, a route reflector G22, and a router G23 are disposed in the AS2. Anode N3, a router G31, and a route reflector G32 are disposed in the AS3.

Assuming that the router in the AS1 needs to communicate with the router in the AS3 by using the routers in the AS2, when the router in the AS1 needs to send a BGP update message to the router in the AS3, the router G12 may first send the BGP update message to the router G21. The BGP update message is sent from the AS1, and therefore an AS path in the BGP update message includes an identifier of the AS1, that is, the AS path is: the AS1. After receiving the BGP update message, the router G21 may determine, based on the AS path (the AS1), that a path length is 1.

The router G21 may send the BGP update message to the router G23 by using the route reflector G22, and the router G23 sends the BGP update message to the router G31. In this case, the BGP update message has passed through the AS2, and therefore the AS path in the BGP update message further includes an identifier of the AS2, that is, the AS path is, the AS2, the AS1. After receiving the BGP update message, the router G31 may determine, based on the AS path (the AS2, the AS1), that the path length is 2.

It should be noted that if a node in the first AS in which the first router is located is in a started state, the first router may directly send the address information of the second node to the node that is in a started state in the first AS. If a first node in the first AS in which the first router is located is not in a started state, the first router may send the cached address information of the second node to the first node after the first node is started.

The following describes, by using S403 to S411, a process of sending the address information of the second node by the first router to the first node.

S403. Start the first node.

S404. The first node sends a first BGP open message to the first router.

The first BGP open message includes indication information used to indicate whether the first node has a capability of carrying the address information of the node.

Optionally, the first BGP open message may further indicate that the first node has been started.

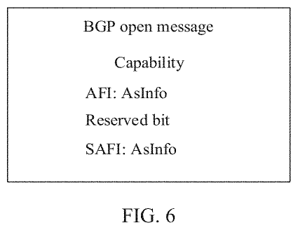

The following describes a structure of the BGP open message in this application with reference to FIG. 6.

FIG. 6 is a schematic structural diagram of a BGP open message according to an embodiment of this application. Referring to FIG. 6, the BGP open message includes an AFI, a reserved bit, and an SAFI. The SAFI is an extended attribute in the existing BGP update message in this application. A value AsInfo of the SAFI may indicate whether a device sending the BGP open message has a capability of carrying the address information of the node.

S405. The first router sends a second BGP open message to the first node based on the first BGP open message.

The second BGP open message includes indication information used to indicate whether the first router has a capability of carrying the address information of the node.

S406. The first node establishes an Internal Border Gateway Protocol (IBGP) connection to the first router based on the second BGP open message.

Optionally, when the first node has the capability of carrying the address information of the node, and the first router also has the capability of carrying the address information of the node, the first node establishes the IBGP connection to the first router.

For example, when the first node determines that the second BGP open message includes the indication information used to indicate whether the first router has a capability of carrying the address information of the node, the first node establishes the IBGP connection to the first router.

S407. The first node sends a second BGP update message to the first router.

The second BGP update message includes address information of the first node.

It should be noted that for a structure of the first BGP update message, refer to FIG. 3. Details are not described herein again.

Optionally, S407 may be an optional step. In other words, S407 may not be performed.

Optionally, in S407, the first node may send the second BGP update message to the first router after receiving a second request message sent by the first router. The second request message is used to request to obtain the address information of the first node.

S408. The first router sends a third BGP update message to the first node.

The third BGP update message includes the address information of the second node.

It should be noted that for a structure of the third BGP update message, refer to FIG. 3. Details are not described herein again.

It should be noted that in S408, the first router may send the third BGP update message to the first node after receiving a first request message sent by the first node. The first request message is used to request to obtain the address information of the node in the neighboring AS (the second AS) of the first AS.

S409. The first node establishes a connection to the second node based on the address information of the second node.

Optionally, the first node may first add the address information of the second node to a neighbor table. After determining that the first node obtains the neighbor table, the first node may first establish a connection to a corresponding node based on address information in the neighbor table. Because the neighbor table includes the address information of the second node, the first node may establish the connection to the second node.

Optionally, the first node may dynamically maintain the neighbor table, so that second nodes in the neighbor table are all reachable (in a started state). For example, before a node in the neighbor table goes offline, the second node may send a go-offline notification to the first node by using the second router and the first router, so that the first node deletes address information of the node from the neighbor table. Alternatively, each time after the first node goes offline, the first node clears the neighbor table. Alternatively, when the first node receives no response after sending a connection request to one of neighboring nodes, the first node determines that the node is not in a started state, and then the first node deletes address information of the node from the neighbor table. It should be noted that the foregoing is merely used as an example to describe a process of dynamically maintaining the neighbor table by the first node. This is not specifically limited in this application.

Optionally, the neighbor table of the first node may include some address information in the third BGP update message. In this case, the first node may not add the some address information to the neighboring node any longer, to avoid that the neighbor table includes repeated address information.

S410. The first router sends a fourth BGP update message to the second router.

The fourth BGP update message includes the address information of the first node.

It should be noted that for a structure of the fourth BGP update message, refer to FIG. 3. Details are not described herein again.

S411. The second router caches the address information of the first node.

Optionally, after the second router caches the address information of the first node, and after the second node in the second AS is started, the second router may send the address information of the first node to the second node.

It should be noted that for a process of sending the information of the first node by the second router to the second node, refer to the process of sending the address information of the second node by the first router to the first node. Details are not described herein again.

It should be noted that S410 and S411 may be optional steps. In other words. S410 and S411 may not be performed. In an actual application process, if S407 is performed, S410 and S411 may also be performed; or if S407 is not performed, S410 and S411 may not be performed either.

In the embodiment shown in FIG. 4, the existing BGP open message is extended, so that the BGP open message may indicate whether the device sending the BGP open message has a capability of carrying the address information of the node. The existing BGP update message is extended, so that the BGP update message can carry the address information of the node. In this way, the first node in the first AS can obtain the address information of the second node in the second AS by using the BGP update message, and then the first node can first establish the connection to the second node based on the address information of the second node. Because the first AS and the second AS are neighbors, the second node in the second AS is a non-attack node, so that the first node can be connected to at least one non-attack node. This can avoid that nodes to which the first node establishes connections are all attack nodes, and further avoid that the first node is controlled by the attack nodes, thereby improving blockchain communication security.

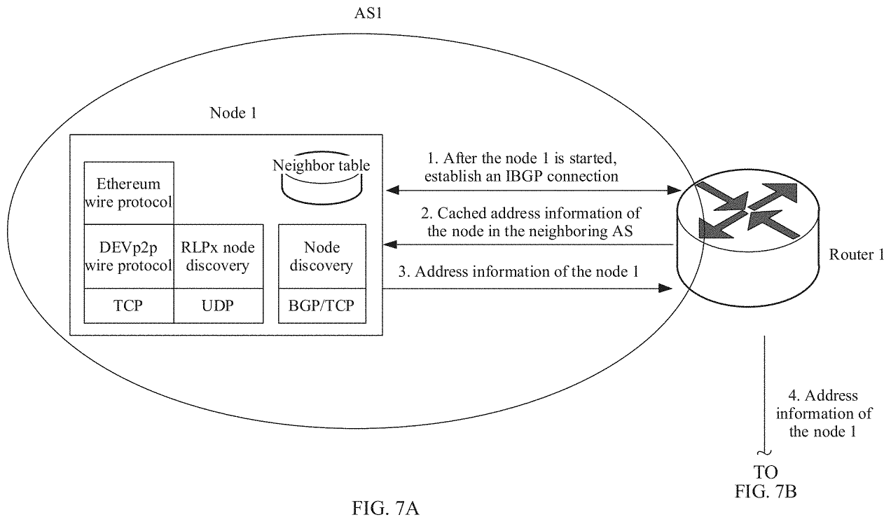

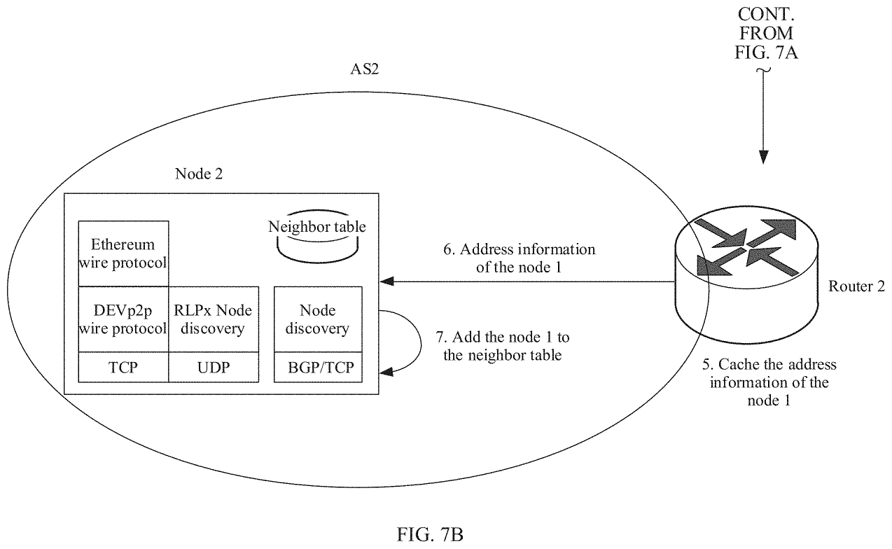

The following details, by using a specific example with reference to FIGS. 7A and 7B, the method is shown in FIG. 4.

FIG. 7A and FIG. 7B are schematic diagrams of a process of establishing a node connection according to an embodiment of this application. Referring to FIG. 1, the node 1 and the router 1 are disposed in the AS1, and the node 2 and the router 2 are disposed in the AS2, where the AS1 and the AS2 are neighbors. It is assumed that the node 1, the node 2, the router 1, and the router 2 all have a capability of adding address information to a BGP update message.

The node 1 and the node 2 are Ethereum nodes, and the Ethereum node is a type of blockchain node. Referring to FIG. 7A and FIG. 7B, the node 1 and the node 2 may communicate with each other based on an Ethereum network protocol.

The Ethereum network protocol is a Developers Peer to Peer (DEVp2p) protocol. The DEVp2p protocol includes a Recursive Length Prefix extended (RLPx) Node Discovery Protocol, an Ethereum Wire Protocol, a DEVp2p Wire Protocol, a User Diagram Protocol (UDP), and a Transmission Control Protocol (TCP). The RLPx Node Discovery (RLPxNode Discover) protocol is used to discover an Ethereum node by using a node discovery algorithm. The DEVp2p Wire Protocol is used to establish a P2P connection between Ethereum nodes. The Ethereum Wire Protocol is used to synchronize transaction block information between Ethereum nodes, participate in consensus, and the like.

Referring to FIGS. 7A and 7B, in step 1, after the node 1 is started, because both the node 1 and the router 1 have a capability of adding address information to a BGP update message, the node 1 can establish an IBGP connection to the router 1.

In step 2, after the node 1 establishes the IBGP connection to the router 1, the router 1 may send address information, cached in the router 1, of the node in the neighboring AS to the node 1. After receiving the address information, sent by the router 1, of the node in the neighboring AS, the node 1 adds the received address information to a neighbor table, and establishes a connection to the node in the neighboring AS based on the address information in the neighbor table. After establishing the connection to the node in the neighboring AS, the node 1 may further establish a connection to a node in a node table. The node table is a reachable-node table of a node that is maintained. For example, the node table may include address information of a node that has been in contact with the node recently and that is reachable for the node.

In step 3, the node 1 sends address information of the node 1 to the router 1. For example, the node 1 may send a BGP update message 1 to the router 1, where the BGP update message 1 includes the address information of the node 1.

In step 4, the router 1 sends the address information of the node 1 to the router 2. For example, the router 1 may send a BGP update message 2 to the router 2, and add the address information of the node 1 to the BGP update message 2. In step 4, if the AS1 and another AS are also neighbors, the router 1 further sends the address information of the node 1 to a router in the another neighboring AS of the AS1.

In step 5, the router 2 may cache the address information of the node 1.

In step 6, assuming that the node 2 in the AS2 is a started state, the router 2 may directly send the address information of the node 1 to the node 2. For example, the router 2 may send a BGP update message 3 to the node 2, where the BGP update message 3 includes the address information of the node 1. It should be noted that if the AS2 further includes another node that has been started, after the router 2 receives the address information of the node 1, the router 2 further sends the address information of the node 1 to the another node that has been started. If the AS2 further includes another node that has not been started, the router 2 may send the address information of the node 1 to the another node that has not been started, after the another node is started.

In step 7, after receiving the address information of the node 1, the node 2 adds the address information of the node 1 to the neighbor table. When the node 2 is started next time, the node 2 may establish the connection to the node in the neighboring AS based on the address information of the node in the neighbor table.

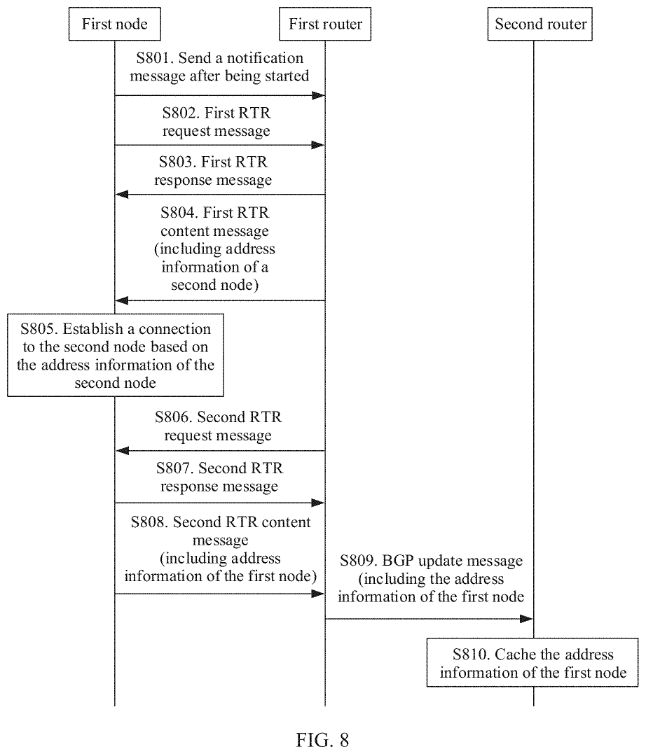

FIG. 8 is a schematic flowchart of still another method for establishing a blockchain node connection according to an embodiment of this application. Referring to FIG. 8, the method may include the following steps.

S801. After a first node is started, the first node sends a notification message to a first router.

The notification message is used to indicate that the first node has been started.

Optionally, the notification message may be a Notify message.

S802. The first node sends a first RTR request message to the first router.

The first Resource Public Key Infrastructure (RPKI) to Router (RPKI To Router, RTR) interface protocol request message is used to request address information of a node in a neighboring AS of a first AS.

Optionally, the first RTR request message may be an implementation of a first request message.

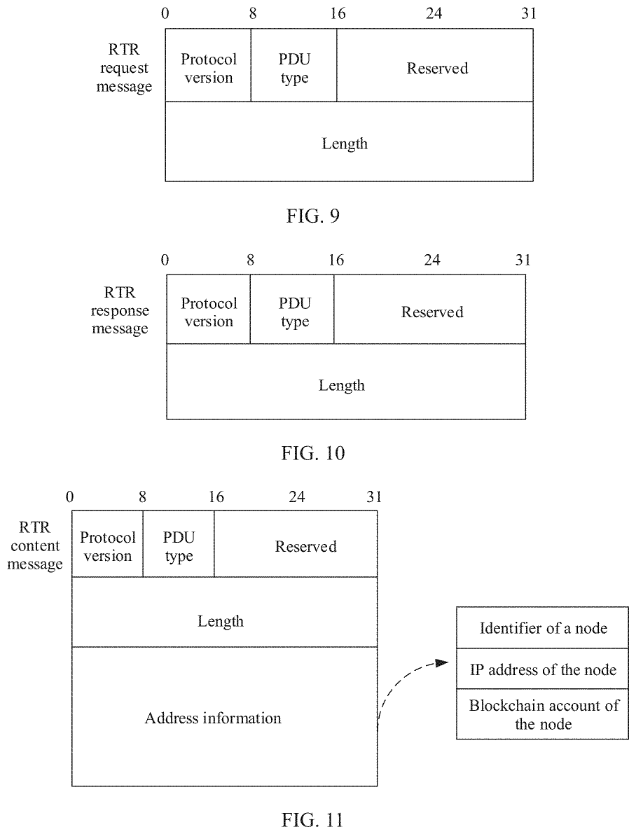

For example, the first RTR request message may be an Account Query message. The Account Query message may be shown in FIG. 9.

FIG. 9 is a schematic structural diagram of a message according to an embodiment of this application. Referring to FIG. 9, the Account Query message may occupy 64 bits. A 0^{th} bit to a 7^{th} bit are used to indicate a protocol version, an 8^{th} bit to a 15^{th} bit are used to indicate a PDU type, a 16^{th} bit to a 31^{th} bit are reserved bits, and a 32^{th} bit to a 63^{th} bit are used to indicate a length. The PDU type may indicate a function of the Account Query message, that is, indicate that the Account Query message is used to request to obtain address information.

S803. The first router sends a first RTR response message to the first node.

Optionally, the first RTR response message may be an Account Response message. The Account Response message may be shown in FIG. 10. Details are not described herein.

FIG. 10 is a schematic structural diagram of another message according to an embodiment of this application. Referring to FIG. 10, the Account Response message may occupy 64 bits. A 0^{th} bit to a 7^{th} are used to indicate a protocol version, an 8^{th} bit to a 15^{th} are used to indicate a PDU type, a 16^{th} bit to a 31^{th} are reserved bits, and a 32^{th} bit to a 63^{th} are used to indicate a length. The PDU type may indicate a function of the Account Query message, that is, responding to the request message about obtaining address information.

S804. The first router sends a first RTR content message to the first node, where the first RTR content message includes address information of a second node.

The second node is the node in the neighboring AS of the first AS. The address information of the second node is the address information, cached in the first router, of the node in the neighboring AS of the first AS.

Optionally, the first RTR content message may be an account information (AccountInfo) message, and the first router adds the address information, cached in the first router, of the node in the neighboring AS to the account information message. The Account Query message may be shown in FIG. 11.

FIG. 11 is a schematic structural diagram of still another message according to an embodiment of this application. Referring to FIG. 11, a quantity of bits occupied by the AccountInfo message is variable. A 0^{th} bit to a 7^{th} bit are used to indicate a protocol version, an 8^{th} bit to a 15^{th} bit are used to indicate a PDU type, a 16^{th} bit to a 31^{th} are reserved bits, a 32^{th} bit to a 63^{th} bit are used to indicate a length, and other information bits are used to indicate address information. The PDU type may indicate a function of the AccountInfo message, that is, indicate that the AccountInfo message is used to carry address information. It should be noted that FIG. 11 is merely used as an example to describe content included in the address information, and does not constitute any limitation on the content included in the address information.

Optionally, after the first router completes sending of the first RTR content message to the first node, the first router may further send an End of Data message to the first node.

S805. The first node establishes a connection to the second node based on the address information of the second node.

It should be noted that for an execution process of S804, refer to S409. Details are not described herein again.

S806. The first router sends a second RTR request message to the first node based on the notification message.

The second RTR request message is used to request to obtain address information of the first node.

Optionally, the second RTR request message may be an implementation of a second request message.

Optionally, the second RTR request message may be an Account Query message. The Account Query message may be shown in FIG. 9. Details are not described herein again.

S807. The first node sends a second RTR response message to the first router based on the Account Query message.

Optionally, the second RTR response message may be an Account Response message. The Account Response message may be shown in FIG. 10. Details are not described herein again.

S808. The first node sends a second RTR content message to the first router based on the Account Query message, where the second RTR content message includes the address information of the first node.

Optionally, the second RTR content message may be an account information (AccountInfo) message. The Account Query message may be shown in FIG. 11. Details are not described herein again.

Optionally, after the first node completes sending of the second RTR response message and the second RTR content message to the first router, the first node may further send an End of Data message to the first router.

It should be noted that an execution sequence between S802 to S804 and S806 to S808 is not limited in this application.

S809. The first router sends a BGP update message to a second router, where the BGP update message includes the address information of the first node.

It should be noted that for a structure of the BGP update message, refer to FIG. 3. Details are not described herein again.

S810. The second router caches the address information of the first node.

Optionally, after the second router caches the address information of the first node, the node in the second AS may request to obtain the address information, cached in the second router, of the neighboring AS from the second router. For a process of requesting to obtain the address information, cached in the second router, of the neighboring AS from the second router by the node in the second AS, refer to S806 and 807. Details are not described herein again.

Optionally, the second router may further request to obtain, from the node in the second AS, the address information of the node in the second AS. For a process thereof, refer to S802 and S803. Details are not described herein again.

In the embodiment shown in FIG. 8, a new RTR message is defined, so that the first node in the first AS can obtain the address information of the second node in the second AS by using the RTR message (the RTR content message), and then the first node can first establish the connection to the second node based on the address information of the second node. Because the first AS and the second AS are neighbors, the second node in the second AS is a non-attack node, so that the first node can be connected to at least one non-attack node. This can avoid that nodes to which the first node establishes connections are all attack nodes, and further avoid that the first node is controlled by the attack nodes, thereby improving blockchain communication security.

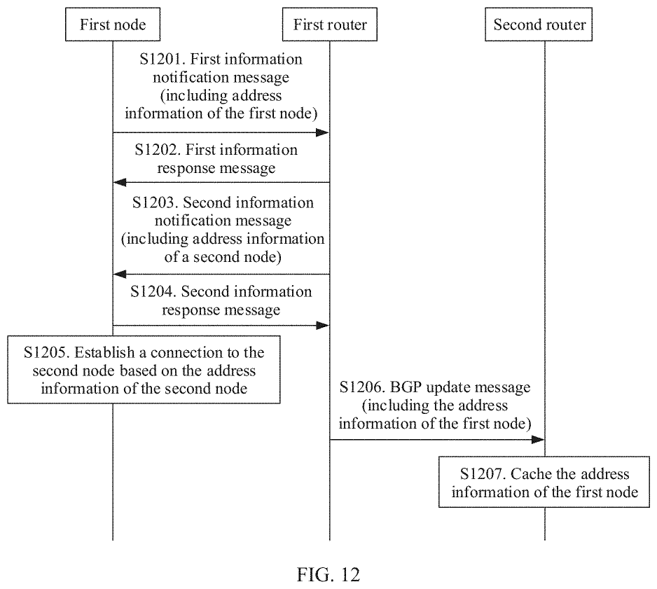

FIG. 12 is a schematic flowchart of yet another method for establishing a blockchain node connection according to an embodiment of this application. Referring to FIG. 12, the method may include the following steps.

S1201. After a first node is started, the first node sends a first information notification message to a first router.

The first information notification message includes address information of the first node.

The first information notification message is further used to indicate that the first node has been started.

Optionally, the first information notification message may be a NotifyAccountInfo message.

Optionally, the first information notification message may be a self-defined interface message. For example, the first information notification message may be a User Datagram Protocol (UDP) message.

S1202. The first router sends a first information response message to the first node.

Optionally, the first information response message may be an Account NotifyAccountAck message.

Optionally, the first information response message may be a self-defined interface message. For example, the first information response message may be a UDP message.

S1203. The first router sends a second information notification message to the first node.

The second information notification message includes address information of a second node, where the second node is a node in a neighboring AS of a first AS. The address information of the second node is address information, cached in the first router, of the node in the neighboring AS of the first AS.

Optionally, the second information notification message may be a NotifyAccountInfo message.

Optionally, the second information notification message may be a self-defined interface message. For example, the second information notification message may be a UDP message.

S1204. The first node sends a second information response message to the first router.

Optionally, the second information response message may be an Account NotifyAccountAck message.

Optionally, the second information response message may be a self-defined interface message. For example, the second information response message may be a UDP message.

S1205. The first node establishes a connection to the second node based on the address information of the second node.

It should be noted that for an execution process of S1205, refer to S409. Details are not described herein again.

S1206. The first router sends a BGP update message to a second router, where the BGP update message includes the address information of the first node.

It should be noted that for a structure of the BGP update message, refer to FIG. 3. Details are not described herein again.

S1207. The second router caches the address information of the first node.

Optionally, after the second router caches the address information of the first node, the second router may further send the address information of the first node to the node in the second AS. For a process of sending the address information of the first node by the second router to the node in the second AS, refer to S1203 and S1204. Details are not described herein again.

In the embodiment shown in FIG. 12, a self-defined interface message is defined, so that the first node in the first AS can obtain the address information of the second node in the second AS by using the self-defined interface message, and then the first node can first establish the connection to the second node based on the address information of the second node. Because the first AS and the second AS are neighbors, the second node in the second AS is a non-attack node, so that the first node can be connected to at least one non-attack node. This can avoid that nodes to which the first node establishes connections are all attack nodes, and further avoid that the first node is controlled by the attack nodes, thereby improving blockchain communication security.

With reference to embodiments shown in FIG. 13 to FIG. 15, the following describes a method for establishing a blockchain node connection.

FIG. 13 is a schematic flowchart of still yet another method for establishing a blockchain node connection according to an embodiment of this application. Referring to FIG. 13, the method may include the following steps.

S1301. Start a first node.

S1302. A first router sends address information, cached in the first router, of a node in a neighboring AS of a first AS to the first node.

It should be noted that for an execution process of S1302, refer to any one of the foregoing method embodiments. Details are not described herein again.

S1303. The first node updates a neighbor table based on the received address information of the node in the neighboring AS of the first AS.

Optionally, the first node may add the received address information of the node in the neighboring AS of the first AS (referred to as a neighboring node below) to the neighbor table; or the first node may add, to the neighbor table, address information that is in the received address information of the neighboring node and that is not included in the neighbor table.

S1304. The first node establishes a connection to the node in the neighboring AS of the first AS based on the address information in an updated neighbor table.

Optionally, the first node may send a connection request to the neighboring node based on the address information in the updated neighbor table, and establishes the connection to the neighboring node after receiving a connection response sent by the neighboring node.

Optionally, the first node establishes outgoing connections to a maximum of └¼(1+maxpeers)┘ neighboring nodes, where maxpeers is a maximum quantity of connections that the first node establishes. For example, maxpeers may be 25.

S1305, the first node performs node discovery based on node information in a node table, and establishes a connection to a discovered node.

Optionally, the first node may generate a random node ID, obtain an exclusive-OR distance between a node ID of each node in the node table and the random node ID, and establish connections to X nodes whose exclusive-OR distances to the random node ID are closest.

Optionally, assuming that the first node establishes connections to Y neighboring nodes in S1304, X+Y is less than or equal to └½(1+maxpeers)┘.

An exclusive-OR distance between two nodes may be a quantity of “1” included in a result obtained after an exclusive OR operation is performed on node IDs of the two nodes.

Optionally, after establishing connections to at least one neighboring node and the discovered node, the first node may obtain blockchain information from the nodes to which the first node establishes the connections, where the blockchain information includes a chain length and difficulty information. If chain lengths or difficulty information obtained by the first node are different, the first node may determine a chain with a greatest chain length and greatest difficulty as a real chain, and establish a connection to the real chain.

In the embodiment shown in FIG. 13, the first node may establish a connection to at least one node in the neighboring AS of the first AS. The node in the neighboring AS of the first AS is a non-attack node, so that the first node can be connected to the at least one non-attack node. This can avoid that nodes to which the first node establishes connections are all attack nodes, and further avoid that the first node is controlled by the attack nodes, thereby improving blockchain communication security.

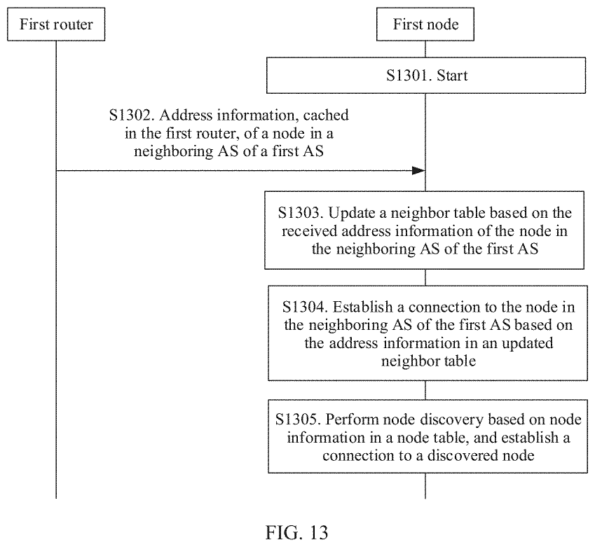

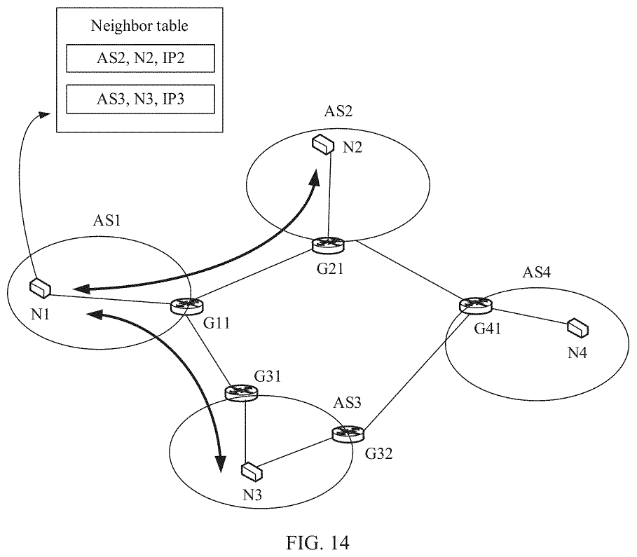

The following details, by using a specific embodiment with reference to FIG. 14, the embodiment is shown in FIG. 13.

FIG. 14 is a schematic diagram of a process of establishing a node connection according to this application. Referring to FIG. 14, an AS1 and an AS2 are neighbors, and the AS1 and an AS3 are neighbors.

After a node N1 is started, the node N obtains address information, cached in a router G11, of nodes in the AS2 and the AS3 from the router G11, and updates a neighbor table based on the obtained address information of the nodes. It is assumed that an updated neighbor table includes address information (IP2) of a node N2 in the AS2 and address information (N3) of a node N3 in the AS3.

The node N1 first establishes connections to neighboring nodes based on the address information of the nodes in the neighbor table. To be specific, the node N1 establishes a connection to the node N2 based on the address (IP2) of the node N2, and the node N1 establishes a connection to the node N3 based on the address (IP3) of the node N3.

The node N1 may further discover another node by using a node discovery algorithm, and establish a connection to the another node. The node N2 and the node N3 are non-attack nodes, so that the node N1 can be connected to at least one non-attack node. This can avoid that nodes to which the node N1 establishes connections are all attack nodes, and further avoid that the node N1 is controlled by the attack nodes, thereby improving blockchain communication security.

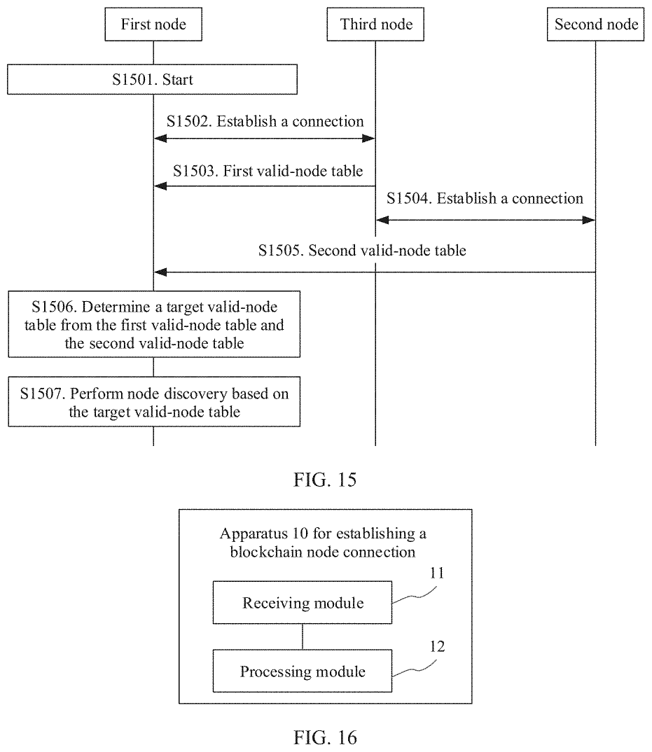

FIG. 15 is a schematic flowchart of a further method for establishing a blockchain node connection according to an embodiment of this application. Referring to FIG. 15, the method may include the following steps.

S1501. Start a first node.

S1502. The first node establishes a connection to a third node.

Optionally, the third node may be an endorsement node.

Optionally, after the first node establishes the connection to the third node, the third node may send first blockchain information to the first node, where the first blockchain information includes a chain length and difficulty information that are of a chain in which the third node is located.

S1503. The third node sends a first valid-node table to the first node.

The first valid-node table includes information about a plurality of nodes.

For example, information about a node may include one or more of the following information: a blockchain account of the node, an identifier of the node, and an IP address of the node.

S1504. The third node establishes a connection to a second node.

The second node is a node in a neighboring AS of a first AS.

It should be noted that for an execution process of S1504, refer to S1302 to S1304. Details are not described herein again.

Optionally, after the first node establishes the connection to the second node, the second node may send second blockchain information to the first node, where the first blockchain information includes a chain length and difficulty information that are of a chain in which the second node is located.

S1505. The second node sends a second valid-node table to the first node.

S1506. The first node determines a target valid-node table from the first valid-node table and the second valid-node table.

Optionally, the first node may determine a real chain based on the first blockchain information and the second blockchain information, and determine, from the first valid-node table and the second valid-node table, a valid-node table that includes a node in the real chain as the target valid-node table.

S1507. The first node performs node discovery based on the target valid-node table.

It should be noted that for an execution process of S1507, refer to S1305. Details are not described herein again.

In the embodiment shown in FIG. 15, the first node may establish a connection to at least one node in the neighboring AS of the first AS. The node in the neighboring AS of the first AS is a non-attack node, so that the first node can be connected to the at least one non-attack node. This can avoid that nodes to which the first node establishes connections are all attack nodes, and further avoid that the first node is controlled by the attack nodes. Further, the first node may obtain the valid-node table separately from the endorsement node and the neighboring node; determine the target valid-node table from the obtained valid-node tables; and perform node discovery based on the target valid-node table. This can further avoid a security problem caused by malicious behavior of the endorsement node.

FIG. 16 is a schematic structural diagram of an apparatus for establishing a blockchain node connection according to an embodiment of this application. The apparatus 10 for establishing a blockchain node connection may be applied to a first node in a blockchain system. The apparatus 10 for establishing a blockchain node connection may include:

a receiving module 11, configured to obtain address information of a second node from a first router, where the first router and the first node are located in a first autonomous system, the second node is located in a second autonomous system, and the first autonomous system and the second autonomous system are neighboring autonomous systems; and

a processing module 12, configured to establish a connection to the second node based on the address information of the second node.

Optionally, the receiving module 11 may perform steps, in the foregoing method embodiments, that are related to receiving actions of the first node. For example, the receiving module 11 may perform S202 in the embodiment in FIG. 2, S405 and S408 in the embodiment in FIG. 4, S803, S804, and the like in the embodiment in FIG. 8, S1202, S1203, and the like in the embodiment in FIG. 12, S1302 in the embodiment in FIG. 13, and S1503 and S1505 in the embodiment in FIG. 15.

Optionally, the processing module 12 may perform steps, in the foregoing method embodiments, that are related to processing actions of the first node. For example, the processing module 12 may perform S203 in the embodiment in FIG. 2, S409 in the embodiment in FIG. 4, S805 in the embodiment in FIG. 8, S1205 in the embodiment in FIG. 12, S1303 to S1305 in the embodiment in FIG. 13, and S1506 and S1507 in the embodiment in FIG. 15.

It should be noted that the apparatus 10 for establishing a blockchain node connection in this embodiment of this application can perform the technical solutions described in the foregoing method embodiments. An implementation principle and beneficial effects thereof are similar to those in the foregoing method embodiments. Details are not described herein again.

In a possible implementation, the receiving module 11 is specifically configured to receive a first message from the first router. The first message includes the address information of the second node. The first message is one of a border gateway protocol BGP message, a resource public key infrastructure to router RTR interface protocol message, or a self-defined interface message.

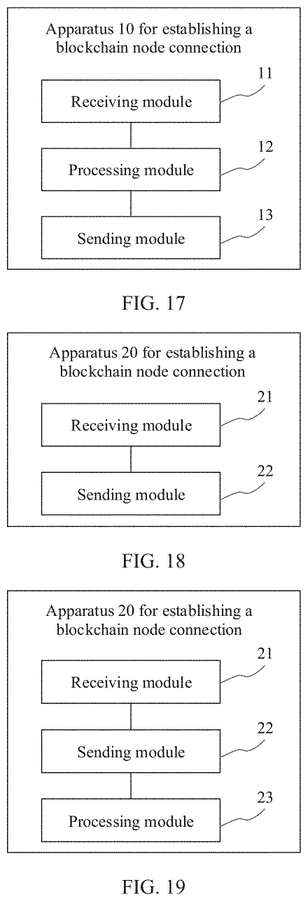

FIG. 17 is a schematic structural diagram of another apparatus for establishing a blockchain node connection according to an embodiment of this application. Based on the embodiment show % n in FIG. 16, referring to FIG. 17, the apparatus 10 for establishing a blockchain node connection further includes a sending module 13, where

the sending module 13 is configured to: before the receiving module 11 receives the first message from the first router, send a request message to the first router. The request message is used to request to obtain the address information of the node in the neighboring autonomous system of the first autonomous system.

Optionally, the sending module 13 may perform steps, in the foregoing method embodiments, that are related to sending actions of the first node. For example, the processing module 12 may perform S202 in the embodiment in FIG. 2, S404 and S407 in the embodiment in FIG. 4, S801, S802, S807, and S808 in the embodiment in FIG. 8, and S1201 and S1204 in the embodiment in FIG. 12.

In a possible implementation, address information of the first node includes at least one of an identifier of the first node, an IP address of the first node, a MAC address of the first node, or a blockchain account of the first node; and

the address information of the second node includes at least one of an identifier of the second node, an IP address of the second node, a MAC address of the second node, or a blockchain account of the second node.

In a possible implementation, before the processing module 12 establishes the connection to the second node based on the address information of the second node, the processing module 12 is further configured to add the address information of the second node to a neighbor table of the first node; and

the processing module 12 is specifically configured to establish the connection to the second node based on the address information in the neighbor table.

In a possible implementation, after the processing module 12 establishes the connection to the second node based on the address information of the second node, the processing module 12 is further configured to:

establish a connection to a third node, and obtain a first valid-node table from the third node;

obtain a second valid-node table from the second node; and

determine a target valid-node table from the first valid-node table and the second valid-node table, and perform node discovery based on the target valid-node table.

It should be noted that the apparatus 10 for establishing a blockchain node connection in this embodiment of this application can perform the technical solutions described in the foregoing method embodiments. An implementation principle and beneficial effects thereof are similar to those in the foregoing method embodiments. Details are not described herein again.

FIG. 18 is a schematic structural diagram of still another apparatus for establishing a blockchain node connection according to an embodiment of this application. The apparatus 20 for establishing a blockchain node connection may be applied to a first router in a blockchain system. The apparatus 20 for establishing a blockchain node connection may include:

a receiving module 21, configured to obtain address information of a second node, where the second node is located in a second autonomous system; and

a sending module 22, configured to send the address information of the second node to the first node, where the first router and the first node are located in a first autonomous system, and the first autonomous system and the second autonomous system are neighboring autonomous systems.

Optionally, the receiving module 21 may perform steps, in the foregoing method embodiments, that are related to receiving actions of the first router. For example, the receiving module 21 may perform S201 in the embodiment in FIG. 2, S401, S404, and S407 in the embodiment in FIG. 4, S801, S802, S807, and S808 in the embodiment in FIG. 8, and S1201 and S1204 in the embodiment in FIG. 12.

Optionally, the sending module 22 may perform steps, in the foregoing method embodiments, that are related to sending actions of the first router. For example, the sending module 22 may perform 202 in the embodiment in FIG. 2, S405, S408, and S410 in the embodiment in FIG. 4, S803, S804, S806, and S809 in the embodiment in FIG. 8, and S1202, S1203, and S1206 in the embodiment in FIG. 12.

It should be noted that the apparatus 20 for establishing a blockchain node connection in this embodiment of this application can perform the technical solutions described in the foregoing method embodiments. An implementation principle and beneficial effects thereof are similar to those in the foregoing method embodiments. Details are not described herein again.

In a possible implementation, the sending module 22 is specifically configured to send a first message to the first node. The first message includes the address information of the second node. The first message is one of a border gateway protocol BGP message, a resource public key infrastructure to router RTR interface protocol message, or a self-defined interface message.

In a possible implementation, the receiving module 21 is further configured to: before the sending module sends the first message to the first node, receive a first request message sent by the first node. The first request message is used to request to obtain the address information of the node in the neighboring autonomous system of the first autonomous system.

In a possible implementation, the receiving module 21 is specifically configured to receive a first border gateway protocol BGP message from a second router. The first BGP message includes the address information of the second node, and the second router is located in the second autonomous system.

FIG. 19 is a schematic structural diagram of yet another apparatus for establishing a blockchain node connection according to an embodiment of this application. Based on the embodiment shown in FIG. 18, referring to FIG. 19, the apparatus 20 for establishing a blockchain node connection may further include a processing module 23, where

the processing module 23 is configured to: before the sending module 22 sends the address information to the first node, obtain an autonomous system path length of the address information, and determine that the autonomous system path length of the address information is 1, where the autonomous system path length is used to indicate a quantity of autonomous systems that the address information has passed through when the first router receives the address information.

In a possible implementation, the receiving module 21 is further configured to receive a second message sent by the first node. The second message includes address information of the first node. The second message is at least one of a BGP message, a resource public key infrastructure to router RTR interface protocol message, or a self-defined interface message.

In a possible implementation, address information of the first node includes at least one of an identifier of the first node, an IP address of the first node, a MAC address of the first node, or a blockchain account of the first node; and

the address information of the second node includes at least one of an identifier of the second node, an IP address of the second node, a MAC address of the second node, or a blockchain account of the second node.

It should be noted that the apparatus 20 for establishing a blockchain node connection in this embodiment of this application can perform the technical solutions described in the foregoing method embodiments. An implementation principle and beneficial effects thereof are similar to those in the foregoing method embodiments. Details are not described herein again.

It should be understood that in the apparatus for establishing a blockchain node connection, the processing module may be implemented by using a processor, the receiving module may be implemented by using a receiver, and the sending module may be implemented by using a transmitter.

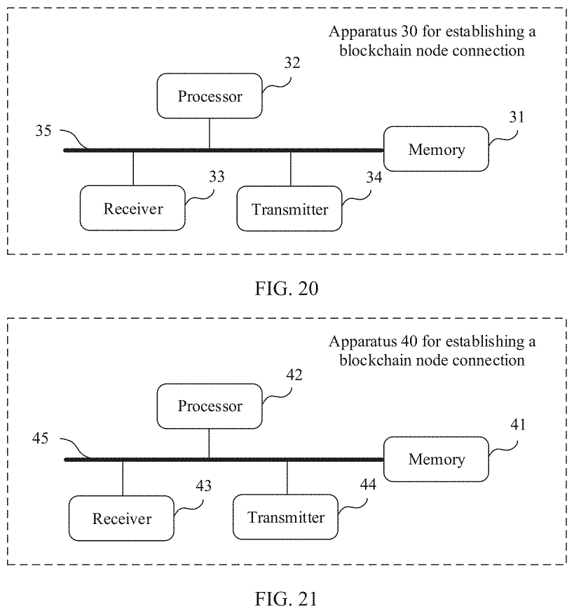

FIG. 20 is a schematic structural diagram of hardware of an apparatus for establishing a blockchain node connection according to this application. Referring to FIG. 20, the apparatus 30 for establishing a blockchain node connection includes a memory 31, a processor 32, a receiver 33, and a transmitter 34, where the memory 31 communicates with the processor 32. For example, the memory 31, the processor 32, the receiver 33, and the transmitter 34 may communicate with each other through a bus 35; the memory 31 is configured to store a computer program; and the processor 32 executes the computer program to implement the foregoing methods for establishing a blockchain node connection.

Optionally, the processor 32 in this application can implement functions of the processing module 12 in the embodiments in FIG. 16 and FIG. 17, the receiver 33 can implement functions of the receiving module 11 in the embodiments in FIG. 16 and FIG. 17, and the transmitter 34 can implement functions of the sending module 13 in the embodiments in FIG. 16 and FIG. 17. Details are not described herein again.

FIG. 21 is a schematic structural diagram of hardware of another apparatus for establishing a blockchain node connection according to this application. Referring to FIG. 21, the apparatus 40 for establishing a blockchain node connection includes a memory 41, a processor 42, a receiver 43, and a transmitter 44, where the memory 41 communicates with the processor 42. For example, the memory 41, the processor 42, the receiver 43, and the transmitter 44 may communicate with each other through a bus 45; the memory 41 is configured to store a computer program; and the processor 42 executes the computer program to implement the foregoing methods for establishing a blockchain node connection.

Optionally, the processor 42 in this application can implement functions of the processing module 23 in the embodiments in FIG. 18 and FIG. 19, the receiver 43 can implement functions of the receiving module 21 in the embodiments in FIG. 18 and FIG. 19, and the transmitter 44 can implement functions of the sending module 22 in the embodiments in FIG. 18 and FIG. 19. Details are not described herein again.

Optionally, the processor may be a central processing unit (CPU), or may be another general purpose processor, a digital signal processor (DSP), an application-specific integrated circuit (ASIC), or the like. The general purpose processor may be a microprocessor, or the processor may be any conventional processor or the like. The steps in the embodiments corresponding to the methods for establishing a blockchain node connection disclosed with reference to this application may be directly performed by a hardware processor, or performed by a combination of hardware in a processor and a software module.

This application provides a storage medium. The storage medium is configured to store a computer program. The computer program is used to implement the methods for establishing a blockchain node connection in the foregoing embodiments.

All or some of the steps of the method embodiments may be implemented by a program instructing related hardware. The foregoing program may be stored in a computer-readable memory. When the program is executed, the steps of the method embodiments are performed. The memory (storage medium) includes: a read-only memory (ROM), a RAM, a flash memory, a hard disk, a solid-state drive, a magnetic tape, a floppy disk, an optical disc, and any combination thereof.

The embodiments of this application are described with reference to the flowcharts and/or block diagrams of the method, the device (system), and the computer program product according to the embodiments of this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a special-purpose computer, an embedded processor, or a processing unit of any other programmable data processing device to generate a machine, so that the instructions executed by a computer or a processing unit of any other programmable data processing device generate an apparatus for implementing a specific function in one or more processes in the flowcharts and/or in one or more blocks in the flowcharts.

These computer program instructions may be stored in a computer-readable memory that can indicate the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the flowcharts.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the flowcharts.

Obviously, persons skilled in the art can make various modifications and variations to embodiments of this application without departing from the spirit and scope of this application. This application is intended to cover these modifications and variations provided that they fall within the scope of protection defined by the following claims and their equivalent technologies.

In this application, the term “include” and variants thereof may mean non-restrictive inclusions, and the term “or” and variants thereof may mean “and/or”. In this application, the terms “first”, “second”, and the like are intended to distinguish between similar objects but do not necessarily indicate a specific order or sequence. “A plurality of” in this application means two or more than two. The term “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

What is claimed is:

1. A method for establishing a blockchain node connection, wherein the method is applied to a blockchain system, and the method comprises:
obtaining, by a first node, address information of a second node from a first router, wherein the first router and the first node are located in a first autonomous system, the second node is located in a second autonomous system, and the first autonomous system and the second autonomous system are neighboring autonomous systems; and
establishing, by the first node, a connection to the second node based on the address information of the second node.

2. The method according to claim 1, wherein the obtaining, by the first node, the address information of the second node from the first router comprises:
receiving, by the first node, a first message from the first router, wherein the first message comprises the address information of the second node, and the first message is one of a border gateway protocol (BGP) message, a resource public key infrastructure to router Resource Public Key Infrastructure (RPKI) to Router (RTR) interface protocol message, or a self-defined interface message.

3. The method according to claim 1, wherein
the address information of the second node comprises at least one of an identifier of the second node, an IP address of the second node, a MAC address of the second node, or a blockchain account of the second node.

4. The method according to claim 1, wherein before the establishing, by the first node, the connection to the second node based on the address information of the second node, the method comprises:
adding, by the first node, the address information of the second node to a neighbor table of the first node; and
wherein the establishing, by the first node, the connection to the second node based on the address information of the second node comprises:
establishing, by the first node, the connection to the second node based on the address information in the neighbor table.

5. The method according to claim 1, wherein after the establishing, by the first node, the connection to the second node based on the address information of the second node, the method further comprises:
establishing, by the first node, a connection to a third node, and obtaining a first valid-node table from the third node;
obtaining, by the first node, a second valid-node table from the second node; and
determining, by the first node, a target valid-node table from the first valid-node table and the second valid-node table, and performing node discovery based on the target valid-node table.

6. A method for establishing a blockchain node connection, wherein the method is applied to a blockchain system, and the method comprises
obtaining, by a first router, address information of a second node, wherein the second node is located in a second autonomous system; and
sending, by the first router, the address information of the second node to a first node, wherein the first router and the first node are located in a first autonomous system, and the first autonomous system and the second autonomous system are neighboring autonomous systems.

7. The method according to claim 6, wherein the sending, by the first router, the address information of the second node to the first node comprises:
sending, by the first router, a first message to the first node, wherein the first message comprises the address information of the second node, and the first message is one of a BGP message, a resource public key infrastructure to router RTR interface protocol message, or a self-defined interface message.

8. The method according to claim 6, wherein the obtaining, by the first router, the address information of the second node comprises:
receiving, by the first router, a first border gateway protocol BGP message from a second router, wherein the first BGP message comprises the address information of the second node, and the second router is located in the second autonomous system.

9. The method according to claim 6, wherein before the sending, by the first router, the address information to the first node, the method further comprises:
obtaining, by the first router, an autonomous system path length of the address information, wherein the autonomous system path length indicates a quantity of autonomous systems that the address information has passed through when the first router receives the address information; and
determining, by the first router, that the autonomous system path length of the address information is 1.

10. The method according to claim 8, wherein the method further comprises:
receiving, by the first router, a second message sent by the first node, wherein the second message comprises address information of the first node, and the second message is at least one of a BGP message, a resource public key infrastructure to router RTR interface protocol message, or a self-defined interface message.

11. The method according to claim 6, wherein
the address information of the second node comprises at least one of an identifier of the second node, an IP address of the second node, a MAC address of the second node, or a blockchain account of the second node.

12. An apparatus for establishing a blockchain node connection, wherein the apparatus is applied to a first node in a blockchain system, and the apparatus comprises:
a receiver, configured to obtain address information of a second node from a first router, wherein the first router and the first node are located in a first autonomous system, the second node is located in a second autonomous system, and the first autonomous system and the second autonomous system are neighboring autonomous systems;
a non-transitory memory storage comprising instructions; and
one or more hardware processors in communication with the non-transitory memory storage, wherein the one or more hardware processors execute the instructions to establish a connection to the second node based on the address information of the second node.

13. The apparatus according to claim 12, wherein
the receiver is configured to receive a first message from the first router, wherein the first message comprises the address information of the second node, and the first message is one of a BGP message, a resource public key infrastructure to router RTR interface protocol message, or a self-defined interface message.

14. The apparatus according to claim 12, wherein
the address information of the second node comprises at least one of an identifier of the second node, an IP address of the second node, a MAC address of the second node, or a blockchain account of the second node.

15. The apparatus according to claim 12, wherein the one or more hardware processors execute the instructions to:
before establishing the connection to the second node based on the address information of the second node, add the address information of the second node to a neighbor table of the first node; and
establish the connection to the second node based on the address information in the neighbor table.

16. The apparatus according to claim 12, wherein the one or more hardware processors execute the instructions to:
after establishing the connection to the second node based on the address information of the second node:
establish a connection to a third node, and obtain a first valid-node table from the third node;
obtain a second valid-node table from the second node; and
determine a target valid-node table from the first valid-node table and the second valid-node table, and perform node discovery based on the target valid-node table.
